(19) United States
(12) Patent Application Publication
(10) Pub. No.: US 2010/0228559 A1
(43) Pub. Date: Sep. 9, 2010

(54) METHODS AND APPARATUS TO ENABLE SHARING OF HEALTHCARE INFORMATION

(76) Inventor: Keith Wayne Boone, Randolph, MA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/397,125

(22) Filed: Mar. 3, 2009

(51) Int. Cl. G06Q 50/00; G06F 17/30; G06F 3/12

(52) U.S. Cl. 705/1.1; 707/769; 358/1.15; 707/E17.014

(57) ABSTRACT

Methods and apparatus to enable sharing of healthcare information are disclosed herein. An example method for use with a medical information system includes receiving healthcare information from an application operating according to a first standard; obtaining context information associated with the healthcare information; generating a document including at least a portion of the healthcare information; and combining the context information and the document to form a standardized message capable of being shared with an information exchange operating according to a second standard.

### FIELD OF THE DISCLOSURE

The present disclosure relates generally to healthcare information systems and, more particularly, to methods and apparatus to enable sharing of healthcare information.

### BACKGROUND

Healthcare environments, such as hospitals and clinics, typically include information systems (e.g., electronic medical record (EMR) systems, lab information systems, outpatient and inpatient systems, hospital information systems (HIS), radiology information systems (RIS), storage systems, picture archiving and communication systems (PACS), etc.) to manage clinical information such as, for example, patient medical histories, imaging data, test results, diagnosis information, management information, financial information, and/or scheduling information. The information may be centrally stored or divided at a plurality of locations. Healthcare practitioners may desire to access patient information or other information at various points in a healthcare workflow. For example, during surgery, medical personnel may access patient information, such as images of a patient's anatomy, which are stored in a medical information system. Further, medical personnel may enter new information, such as medical history, diagnostic, financial, or treatment information into a medical information system before and/or after a completed medical procedure, analysis, and/or appointment.

With the increase in use of electronic medical records, there is an increased recognition of the advantages of sharing medical data among healthcare facilities (e.g., a physician's office, a hospital, a clinic, etc.). Efforts are underway to connect healthcare information systems and to do so in a secure, sustainable, and standards-based manner. For example, standards have been selected by the Health Information Technology Standards Panel and recognized by the Secretary of Health and Human Services. The necessary infrastructure is being developed by organizations such as the National Health Information Network (NHIN), which is led by the United States federal government, and other Regional Health Information Organizations (RHIOs).

### SUMMARY

An example method for use with a medical information system includes receiving healthcare information from an application operating according to a first standard. Further, the example method includes obtaining context information associated with the healthcare information. Further, the example method includes generating a document including at least a portion of the healthcare information. Further, the example method includes combining the context information and the document to form a standardized message capable of being shared with an information exchange operating according to a second standard.

An example apparatus for use with a medical information system includes a context manager to obtain context information associated with healthcare information received from an application operating according to a first standard. Further, the example apparatus includes a print unit to generate a document including at least a portion of the healthcare information. Further, the example apparatus includes a standardized message generator to combine the context information and the document to form a standardized message capable of being shared with an information exchange operating according to a second standard.

An example medical data sharing system includes a healthcare enterprise communicatively coupled to a health information exchange, wherein the health information exchange operates according to a first standard. Further, the example medical data sharing system includes a medical information system associated with the healthcare enterprise including a plurality of sources of healthcare information. Further, the example medical data sharing system includes an application capable of communicating with at least one of the sources of healthcare information, wherein the application operates according to a second standard different from the first standard. Further, the example medical data sharing system includes an example print driver configured to receive an instance of healthcare information from the application. The example print driver includes a context manager to obtain context information associated with the instance of healthcare information. Further, the example print driver includes a print unit to generate a document including at least a portion of the instance of healthcare information. Further, the example print driver includes a standardized message generator to combine the context information and the document to form a message standardized in accordance with the first standard of the health information exchange.

### BRIEF DESCRIPTION OF THE DRAWINGS

FIG. 1 is a block diagram of an example healthcare information system.

FIG. 2 is a block diagram of an example apparatus that may be used to implement the example print driver of FIG. 1.

FIG. 3 is a flow diagram representative of example machine readable instructions that may be executed to implement the example print driver of FIGS. 1 and/or 2.

FIG. 4A is an example screenshot illustrative of an example display associated with the example print driver of FIGS. 1 and/or 2 and/or the example machine readable instructions of FIG. 3.

FIG. 4B is an example screenshot illustrative of an example display associated with the example print driver of FIGS. 1 and/or 2 and/or the example machine readable instructions of FIG. 3.

FIG. 4B is an example screenshot illustrative of an example display associated with the example print driver of FIGS. 1 and/or 2 and/or the example machine readable instructions of FIG. 3.

FIG. 5 is a block diagram of an example processor system that may be used to execute the machine readable instructions of FIG. 3 to implement the example print driver of FIGS. 1 and/or 2.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

The example methods, apparatus, systems, and/or articles of manufacture described herein can be used to enable sharing of healthcare information across, for example, health information exchanges and/or regional health information organizations. Health information exchanges (HIE) and Regional Health Information Organizations (RHIO) are designed to enable a plurality of healthcare enterprises to exchange healthcare information via, for example, centralized source(s) of information. The centralized source of information is continuously updated by a range of healthcare enterprises, thereby reducing inaccuracies, minimizing time and resources dedicated to retrieving updated healthcare records (e.g., medical and/or financial histories), providing interoperability between the participating healthcare enterprises, and/or affording patients and practitioners additional or alternative benefits.

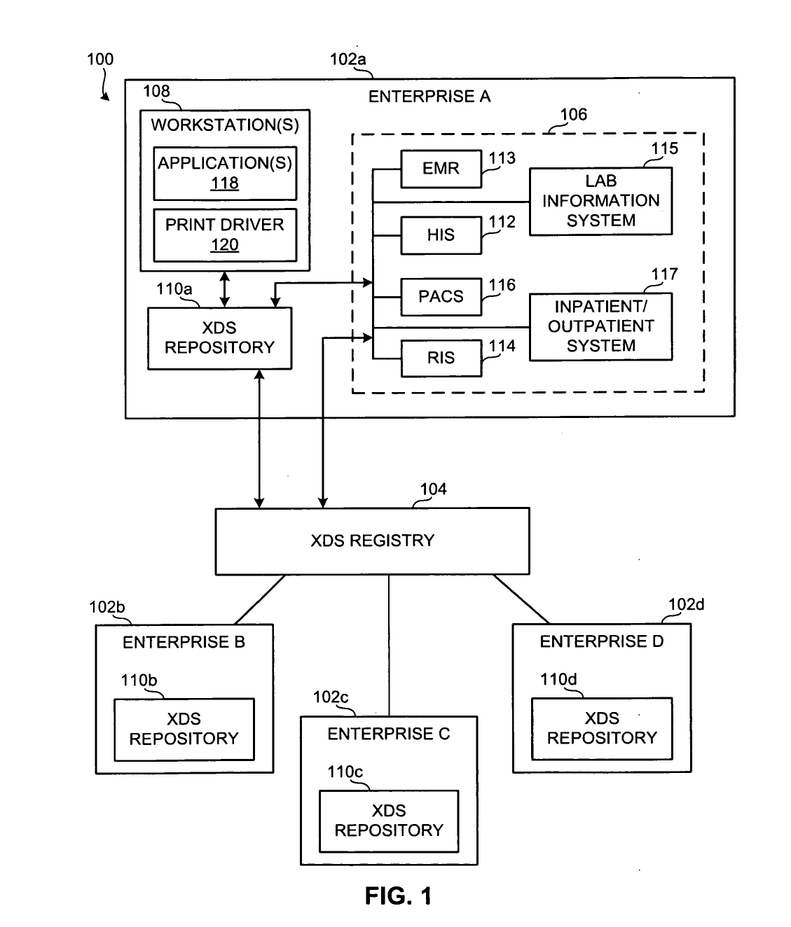

To enable an HIE and/or RHIO to implement the centralized source(s) of information, standards and/or standardized systems have been developed by certain organizations and adopted by healthcare enterprises and/or individual practitioners. For example, Integrating the Healthcare Enterprise (IHE) developed Cross Enterprise Document Sharing (XDS), which is a profile designed to facilitate the sharing of healthcare documents between healthcare enterprises. An example XDS system is described in greater detail below in connection with FIG. 1. An XDS system may utilize one or more standards such as, for example Health Level Seven's (HL-7) Clinical Document Architecture (CDA), which is an Extensible Markup Language (XML)-based standard intended to specify the encoding, structure and semantics of clinical documents for exchange across multiple platforms. The CDA format includes a header to identify and/or classify the associated document and to provide information on authentication, the corresponding encounter and/or event, the patient, the corresponding healthcare providers, etc. Further, the CDA format includes a body including the actual healthcare document (e.g., a medical report, lab results, financial data, etc.). Other example standards include, for example, HL-7 Version 2.0 MDM (Medical Document Management) messages.

Another example includes HL-7's Clinical Context Object Workgroup (CCOW), which is a standard protocol designed to enable an interoperability across disparate applications being executed by, for example, a healthcare practitioner on a healthcare information device (e.g., a medical workstation at a hospital or clinic). The CCOW standard uses a technique referred to as “context management” to provide a unified view of information associated with separate and/or different healthcare applications related to the same practitioner, patient, and/or healthcare event (e.g., an appointment, test, analysis, trauma, procedure, etc.). That is, when a practitioner enters patient identifying data into a CCOW-enabled system, the patient's information is synchronized with a plurality of different applications. The CCOW system includes a central server called a context manager, which is accessible by, for example, a healthcare workstation. Once a practitioner logs onto an authenticating application, the practitioner is automatically logged onto each of the applications associated with the CCOW-enabled system. Each of these applications can then contribute to a unified presentation of information related to, for example, a patient in which the practitioner has expressed an interest (e.g., by searching for medical data related to the patient and/or entering a patient identifier associated with the patient).

However, not all healthcare enterprises have adopted and/or are currently able to support such standards. Some healthcare enterprises have adopted certain standard(s) for certain application(s), but have not yet adopted standard(s) for other application(s). Furthermore, a healthcare enterprise that has adopted a first standard for a certain application may encounter difficulties when attempting to communicate or otherwise interact with an HIE and/or RHIO that operates based on a second, different standard.

In conventional systems confronted with such instances, a complex configuration of an application (e.g., an application not adapted to the standard used by the HIE and/or RHIO with which the application is attempting to communicate) is needed to communicate (e.g., upload/download healthcare documentation) with the HIE and/or RHIO. The configuration often involves having to send a message (e.g., an HL-7 message or Digital Imaging and Communication in Medicine (DICOM) message) to a separate application referred to as an interface engine. The interface engine is programmed to convert the message to a document (e.g., an electronic file) that is formatted and/or configured such that the document can be shared with the HIE and/or RHIO.

To perform this conversion, the interface engine is configured with large amounts information due to the varying applications used from one healthcare enterprise to another. Many of these applications utilize additional or alternative format(s) (e.g., message format(s)) and/or encoding. Further, different types of healthcare data from the same application may involve additional or alternative format(s) and/or encoding. The interface engine is configured to perform the conversion described above according to each of these additional or alternative format(s) and/or encoding. That is, a specific knowledge of the formatting and/or encoding used by an application is often needed by conventional systems to enable a document or file associated with the application to be communicated to or from the HIE. Further, each of the applications is typically configured and/or altered to communicative cooperate with the interface engine. Of course, the applications may differ in other manners than formatting and/or encoding that cause the interface engine to be updated and/or reprogrammed to accommodate the differing applications. Thus, operation of the interface engine involves vast amounts of data, updates, maintenance requirements, etc.

The example methods, apparatus, systems, and/or articles of manufacture described herein can be used to minimize and/or eliminate the need for an interface engine in an HIE and/or RHIO. In particular, the example methods, apparatus, systems, and/or articles of manufacture described herein enable a user to print a healthcare document (e.g., a medical report, financial statements, lab results, etc.) such that the printed document can be shared across an HIE and/or RHIO whether or not the application generating the document operates in accordance with the standard(s) of the HIE and/or RHIO. Thus, a healthcare enterprise using one or more application(s) that are unsupportive of the necessary standard(s) can use the example printer driver described herein to generate healthcare documents that are standardized in accordance with the corresponding HIE and/or RHIO without having to alter the unsupportive applications and/or implementing or making use of an interface engine).

FIG. 1 is a block diagram of an example medical data sharing system 100 capable of implementing the example methods, apparatus, systems, and/or articles of manufacture described herein to share healthcare information. The example medical data sharing system 100 of FIG. 1 implements an XDS integration profile to facilitate the sharing (e.g., registration, distribution, access, etc.) of medical data among a plurality of healthcare enterprises 102a-d (referred to as an Affinity Domain in IHE XDS terminology) via a common registry 104. As described above, the XDS profile includes a common set of standards or policies for the healthcare enterprises 102a-d, which agree to share medical data using a common infrastructure. While the example medical data sharing system 100 of FIG. 1 is shown as implemented by an XDS integration profile, any additional or alternative medical data sharing system can be used to implement the example methods, apparatus, systems, and/or articles of manufacture described herein.

In the illustrated example of FIG. 1, the enterprise labeled with reference numeral 102a is illustrated and described herein as a hospital. However, any of the enterprises 102a-d may be any type of healthcare facility such as, for example, a clinic, a physician's office, a laboratory, a testing center, etc. Further, while FIG. 1 illustrates the components of the hospital 102a, the other enterprises (enterprises 102b-d) may include additional, alternative, and/or similar components, although not shown for purposes of brevity and not limitation.

The example hospital 102a includes a medical information system 106, one or more workstations 108, and a repository 110a. The medical information system 106 includes a hospital information system (HIS) 112, an electronic medical record system (EMR) 113, a radiology information system (RIS) 114, a lab information system 115, a picture archiving and communication system (PACS) 116, and an inpatient/outpatient system 117. In the illustrated example, the hospital information system 112, the electronic medical record system 113, the radiology information system 114, the lab information system 115, the PACS 116, and the inpatient/outpatient system 117 are housed in the hospital 102a and locally archived. However, in other implementations, the hospital information system 112, the electronic medical record system 113, the radiology information system 114, the lab information system 115, the PACS 116, and/or the inpatient/outpatient system 117 may be housed one or more other suitable locations. Furthermore, one or more components of the medical information system 106 may be combined and/or implemented together. For example, the radiology information system 114 and/or the PACS 116 may be integrated with the hospital information system 112; the PACS 116 may be integrated with the radiology information system; and/or the six example information systems 112, 113, 114, 115, 116, and/or 117 may be integrated together. Preferably, information (e.g., test results, observations, diagnosis, discharges, admissions, etc.) is entered into the information system(s) 112, 113, 114, 115, 116, and/or 117 by healthcare practitioners (e.g., radiologists, physicians, technicians, administrators, etc.) before, after, and/or during a patient examination and/or testing session.

The hospital information system 112 stores healthcare information such as clinical reports, patient information, practitioner information, and/or financial data received from, for example, personnel at a hospital, clinic, and/or a physician's office. The EMR system 113 stores administrative information related to patients and/or practitioners, medical histories, current treatment records, etc. In some examples, the EMR system 113 stores information according to one or more departmental assignments and/or designations. The radiology information system 114 stores information such as, for example, radiology reports, messages, warnings, alerts, patient scheduling information, patient demographic data, patient tracking information, and/or physician and patient status monitors. Additionally, the radiology information system 114 enables exam order entry (e.g., ordering an x-ray of a patient) and image and film tracking (e.g., tracking identities of one or more people that have checked out a film).

The lab information system 115 stores clinical information such as lab results, test scheduling information, corresponding practitioner(s), and/or other information related to the operation(s) of one or more labs at the corresponding healthcare facility. The PACS 116 stores medical images (e.g., x-rays, scans, three-dimensional renderings, etc.) as, for example, digital images in a database or registry. Images are stored in the PACS 116 by healthcare practitioners (e.g., imaging technicians, physicians, radiologists) after a medical imaging of a patient and/or are automatically transmitted from medical imaging devices to the PACS 116 for storage. In some examples, the PACS 116 may also include a display device and/or viewing workstation to enable a healthcare practitioner to communicate with the PACS 116. The inpatient/outpatient system 117 stores information related to the admission and discharge of patients such as follow up schedules, patient instructions provided by a practitioner, prescription information, presenting symptoms, contact information, etc.

While example types of information are described above as being stored in certain elements of the medical information system 106, different types of healthcare data may be stored in one or more of the hospital information system 112, the EMR system 113, the radiology information system 114, the lab information system 115, the PACS 116, and/or the inpatient/outpatient system 117. Further, the information stored in these elements may overlap and/or share types of data.

The hospital information system 112, the EMR system 113, the radiology information system 114, the lab information system 115, the PACS 116, and/or the inpatient/outpatient system 117 may be in communication via, for example, a Wide Area Network (WAN) such as a private network or the Internet. More generally, any of the coupling(s) described herein, such as the coupling(s) between the registry 104 and any of the enterprises 102a-d, may be via a network. In such instances, the network may be implemented by, for example, the Internet, an intranet, a virtual private network, a wired or wireless Local Area Network, and/or a wired or wireless Wide Area Network. In some examples, the medical information system 106 also includes a broker (e.g., a Mitra Imaging's PACS Broker) to allow medical information and medical images to be transmitted together and stored together.

In some examples, information stored in one or more components of the medical information system 106 is formatted according to the HL-7 clinical communication protocol, the DICOM protocol, and/or any other suitable standard and/or protocol. The equipment used to obtain, generate, and/or store the information of the medical information system 106 may operate in accordance with the HL-7 clinical communication protocol, the DICOM protocol, and/or any other suitable standard and/or protocol. In some examples, the equipment used to obtain, generate, and/or store the information of the medical information system 106 may not operate in accordance with a standardized protocol. As described above, such differences in the modes of operation of medical equipment leads to complexities (e.g., the interface engine described above) encountered when attempting to share related healthcare documents in, for example, an HIE and/or an RHIO.

The repository 110a, which is shown as an XDS repository in the example of FIG. 1, facilitates the sharing of healthcare documents generated by the medical information system 106 with other enterprises (e.g., enterprises 102b-d). In particular, the repository 110a receives images, medical reports, administrative information, financial data, insurance information, and/or other healthcare information from the medical information system 106 and stores such information in, for example, a database or any suitable data structure. Thus, to use XDS terminology, the medical information 106 is a document source that provides the repository 110a clinical data to be shared among the enterprises 102a-d. As shown in the example of FIG. 1, each of the enterprises 102b-d includes an XDS repository 110b-d that functions in a similar manner as the repository 110a of the hospital 102a.

Further, the repository 110a receives metadata associated with the images, medical reports, administrative information, financial data, insurance information, and/or other healthcare information from the medical information system 106 and forwards the metadata to the registry 104, which stores the metadata in a database. The metadata is used by the registry 104 to index the healthcare information stored at the repository 110a (along with the information stored at the repositories of the other enterprises 102b-d). The metadata corresponds to one of more types of identifying information (e.g., identification numbers, patient names, record numbers, or any other identifying information) associated with, for example, medical reports stored at the repository 110a. As described in greater detail below, the registry 104 is capable of receiving queries into the contents of the repositories (e.g., the repository 110b of enterprise 102b) of the medical data sharing system 100 and using the indexed metadata to satisfy the queries. For example, the registry 104 can perform a search of its contents and provide feedback (e.g., requesting clinical data or an indication of the lack thereof) regarding the same to one or more of the enterprises 102a-d and/or, more specifically, the repositories 110a-d.

The workstation(s) 108 may be any equipment (e.g., a personal computer) capable of executing software that permits electronic data (e.g., medical reports) and/or electronic medical images (e.g., x-rays, ultrasounds, MRI scans, medical reports, test results, etc.) to be acquired, stored, or transmitted for viewing and operation. The workstation(s) 108 receive commands and/or other input from a user (e.g., a physician, surgeon, nurse, or any other healthcare practitioner) via, for example, a keyboard, mouse, track ball, microphone, etc. The workstation(s) 108 can communicate with each other, the medical information system 106, and/or, as described in greater detail herein, with the XDS repository 110a and registry 104 to obtain shared medical information and convey the same to the user of the workstation(s) 108. Further, the workstation(s) 108 are capable of implementing a user interface to enable a healthcare practitioner to interact with the medical data sharing system 100 and/or the registry 104 and the components thereof. In some examples, the user interface enables a search of one or more components or elements of the medical data sharing system 100 and/or one or more external databases containing relevant healthcare information. A healthcare practitioner can use such a user interface to search medical resources using different criteria such as, for example, a patient name, a patient identification number, date(s) of treatment(s), type(s) of treatment, and/or any other suitable search criteria. In some examples, the healthcare practitioner logs on to the medical data sharing system 100 before using the search interface and, thus, makes his or her identity known to the system. That is, the user interface is aware of which healthcare practitioner is using the system and, in some examples, creates an identification entry in a memory (e.g., a temporary memory entry) corresponding to the identified healthcare practitioner.

To interact with one or more components of the medical information system 106, the workstation(s) 108 include and/or implement one or more example applications 118. The application(s) 118 are programmed to, for example, retrieve information from a corresponding component of the medical information system 106, configure equipment associated with a corresponding component of the medical information system 106, present data associated with a corresponding component of the medical information system 106, and/or otherwise interact with one or more components of the medical information system 106. In the example of FIG. 1, each of the application(s) 118 is configured to interact with a specific component of the medical information system 106. For example, a PACS application is used to interact with the PACS 116, an inpatient/outpatient application is used to interact with the inpatient/outpatient system 117, etc. In some examples, one or more of the application(s) 118 may be configured and/or programmed to interact with more than one component of the medical information system 106. The example application(s) 118 also include applications not directly related to the medical information system 106. For example, the applications(s) 118 may include Microsoft Word® or Notepad® or any other application with access to or having print capabilities. The example methods, apparatus, systems, and/or articles of manufacture described herein can also be applied to such non-medical applications.

In the illustrated example, certain application(s) 118 operate according to standard(s) and/or protocol(s). The standard(s) and/or protocol(s) by which the application(s) 118 operate (e.g., according to the corresponding component of the medical information system 106) may vary from application to application. As described above, some or all of the standard(s) and/or protocol(s) by which the application(s) 118 operate may not comply or correspond with the standard(s) and/or protocol(s) required to communicate with an HIE and/or RHIO. In the example of FIG. 1, the standard(s) and/or protocol(s) associated with one or more of the application(s) 118 may not comply with the XDS profile associated with the XDS repositories 110a-d, the XDS registry 104, etc. That is, some of the application(s) 118 implemented in the workstation(s) 108 of the first healthcare enterprise 102a may not operate according to the standard(s) and/or protocol(s) necessary to share healthcare documents with the other healthcare enterprises 102b-d via the example XDS profile of FIG. 1. Such application(s) 118 are sometimes referred to herein as non-compliant applications. As described above, conventional systems were forced to alter non-compliant applications and/or implement supplemental device(s) or tool(s) (e.g., the interface engine described above) to enable communication with an HIE and/or RHIO.

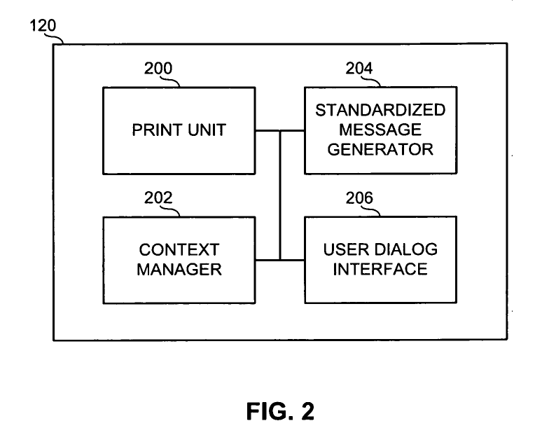

To enable non-compliant applications to efficiently share healthcare documents across the medical data sharing system 100 of FIG. 1, the workstation(s) 108 include a print driver 120. As described in greater below in connection with FIG. 2, the example print driver 120 of FIG. 1 enables a user of the application(s) 118 to create a document (e.g., an electronic file representative of a healthcare record) capable of being shared across the medical data sharing system 100 independent of whether or not the application(s) 118 comply with the standard(s) and/or protocol(s) of the HIE and/or RHIO (e.g., the XDS system of FIG. 1). The example print driver 120 reduces and/or eliminates the need for compliance alterations (e.g., changes made to comply with the HIE and/or RHIO standard(s) and/or protocol(s)) to non-compliant applications. Additionally, the example print driver 120 reduces and/or eliminates the need to supplement non-compliant applications with additional devices or tools, such as an interface engine, to comply with the HIE and/or RHIO standard(s) and/or protocol(s). As described above, an interface engine requires specific configurations, which often need updating, for each of the non-compliant applications and must be aware of which application has produced the information to be standardized. In contrast, the example print driver 120 described herein is capable of receiving information from an application and generating a corresponding standardized message to be shared across an HIE and/or RHIO without specific knowledge of the message format typically exchanged by the application. That is, the example print driver 120 described herein can generate standardized messages independent of which application (e.g., compliant or non-compliant) has generated the corresponding information and without specific configurations for each of the various types of healthcare applications producing the corresponding information.

FIG. 2 is a block diagram of an example apparatus that may be used to implement the example print driver 120 of FIG. 1. In the illustrated example of FIG. 2, the example print driver 120 includes a print unit 200, a context manager 202, a standardized message generator 204, and a user dialog interface 206. While an example manner of implementing the print driver 120 of FIG. 1 has been illustrated in FIG. 2, one or more of the elements, processes and/or devices illustrated in FIG. 2 may be combined, divided, re-arranged, omitted, eliminated and/or implemented in any other way. Further, the example print unit 200, the example context manager 202, the example standardized message generator 204, the example user dialog interface 206, and/or, more generally, the print driver 120 of FIG. 2 may be implemented by hardware, software, firmware and/or any combination of hardware, software and/or firmware. Thus, for example, any of the example print unit 200, the example context manager 202, the example standardized message generator 204, the example user dialog interface 206, and/or, more generally, the print driver 120 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example print unit 200, the example context manager 202, the example standardized message generator 204, the example user dialog interface 206, and/or, more generally, the print driver 120 of FIG. 2 are hereby expressly defined to include a tangible medium such as a memory, DVD, CD, etc., storing the software and/or firmware. Further still, the example print driver 120 of FIG. 2 may include one or more elements, processes and/or devices in addition to, or instead of, those illustrated in FIG. 2, and/or may include more than one of any or all of the illustrated elements, processes and devices.

Generally, the example print driver 120 of FIG. 2 uses context information and healthcare documentation to create a standardized message capable of being shared across the medical data sharing system 100 of FIG. 1. In particular, the example print driver 120 of FIG. 2 combines the context information and the healthcare documentation in a manner such that non-compliant data (e.g., data that would typically need to be conveyed to an interface engine) becomes standardized to support communication of the data to and/or from an HIE and/or RHIO. Example context information to be utilized by the example print driver 120 includes data associated with identifying information (e.g., metadata) corresponding to a patient, a medical event, financial data (e.g., a charge item), test results, etc. That is, context information identifies one or more aspects and/or characteristics associated with a healthcare record or document, such as the associated patient. Example healthcare documentation to be utilized by the example print driver 120 includes output(s) of the any of the components of the medical information system 106 obtained via, for example, the application(s) 118 on the workstation(s) 108. That is, the example healthcare documentation to be utilized by the example print driver 120 includes substantive medical, clinical, and/or financial data such as, for example, medical images, lab results, examination notes, medical recommendations, surgical procedures, etc.

To capture information obtained and/or generated by the application(s) 118, the example print driver 120 of FIG. 2 includes the print unit 200. The example print unit 200 receives data from the application(s) 118 such as, for example, medical images, lab results, examination notes, medical recommendations, surgical procedures, etc. As described above, the application(s) 118 interact with the medical information system 106 to obtain and/or generate such data. The example print unit 200 of FIG. 2 receives the application data and converts the same to the healthcare documentation (e.g., an object to be combined with certain context information associated with the application information). The healthcare documentation generated by the print unit 200 is sometimes referred to herein as a rendered document. In the illustrated example, the print unit 200 converts the application data into a PDF document, a TIFF image, and/or a plain text (e.g., ASCII) file using the native operating system print capabilities. The rendered document may be converted to any other suitable type of file in addition to or in place of those listed herein.

To obtain and/or generate the context information associated with the rendered document, the example print driver 120 of FIG. 2 includes the context manager 202. In the illustrated example of FIG. 2, the context manager 202 utilizes a CCOW system, which is an HL-7 standard protocol, to provide obtain the context information. As described above, a CCOW-enabled system enables a system (e.g., the workstation(s) 108 of FIG. 1) running a plurality of applications (e.g., the application(s) 118 of FIG. 1) to synchronize in real time and to present a unified view of information associated with, for example, a specific patient or encounter (e.g., an appointment, a visit, a procedure, etc.). To provide such functionality, a CCOW server maintains information associated with specific patients and encounters. Given access to the context manager 202, a user of a CCOW-enabled system needs only to enter identifying information associated with a patient or encounter once and the user is simultaneously granted access to information associated with most or all of the applications (e.g., the application(s) 118 of FIG. 1) running on the CCOW-enabled system. That is, the CCOW-enabled system includes context management tools to provide context information to a workstation.

When the example print driver 120 of FIG. 2 receives non-compliant information from one of the applications 118, the example context manager 202 obtains context information associated with the non-compliant information such as, for example, a patient identifier(s), financial status indicator(s), billing address(es), mailing address(es), insurance indicator(s), and/or any other context information. As described above, this context information enables a standardization of the healthcare information such that the healthcare information is able to be shared across an HIE and/or RHIO. While the example context manager 202 utilizes a CCOW context manager to obtain the context information, some examples may obtain additional or alternative sources of context information such as, for example, IHE PIX (Patient Identifier Cross Referencing) or PDQ (Patient Demographics Query Profile) messages. That is, the CCOW context manager is one example source of the context information and the example methods, apparatus, systems, and/or articles of manufacture described herein can obtain the context information from any suitable source.

As an additional or alternative source of context information, the example print driver 120 includes the user dialog interface 206. In the illustrated example, the user dialog interface 206 uses the user interface described above in connection with the workstation(s) 108 to communicate with a user (e.g., a healthcare practitioner). The example user dialog interface 206 receives identifying information such as, for example, a patient identifier (e.g., a assigned alphanumeric identifier assigned to the patient during one or more visits or appointments) or encounter identifier to be used as the context information described herein. In some examples, the user dialog interface 206 enables a query for a patient or encounter based on demographics, dates, and/or any other data useful in finding an item of interest. For example, the user dialog interface 206 may be configured to integrate with an EMPI (enterprise master patient/person index) system that supports the IHE PIX profile for query by identifier. Additionally or alternatively, the user dialog interface 206 may be configured to integrate with an EMPI system that supports the IHE PDQ for query by demographics. In some examples, the user dialog interface 206 provides a user interface review associated with the context information and/or the corresponding generated material.

To generate a standardized message for communication to and/or from an HIE and/or RHIO, the example print driver 120 of FIG. 2 includes the standardized message generator 204. The example standardized message generator 204 of FIG. 2 combines the rendered document generated by the print unit 200 and the context information obtained and/or generated by the context manager 202. The resulting standardized message can be shared with external system(s) (e.g., one or more HIEs and/or RHIOs). In some examples, the standardized message generator 204 generates an HL-7 Version 2.0 MDM (Medical Document Management) message having the context information (e.g., as obtained via the context manager 202 or the user dialog interface 206) in standardized format with the payload of the HL-7 message including the rendered document (e.g., as generated by the print unit 200). In some examples, the standardized message generator 204 generates an HL-7 Version 3.0 Medical Records message using the context information and the rendered document in a similar manner. In illustrated example of FIG. 2, the standardized message generator 204 generates an IHE XDS Provide and Register message using either the XDS.a or XDS.b message structure.

The standardized message generated by the standardized message generator 204 may include the rendered document in the native format produced by the print unit 200. Additionally or alternatively, the generated standardized message may include the rendered document wrapped within a standard healthcare document format such as, for example, the HL-7 Clinical Document Architecture 2.0.

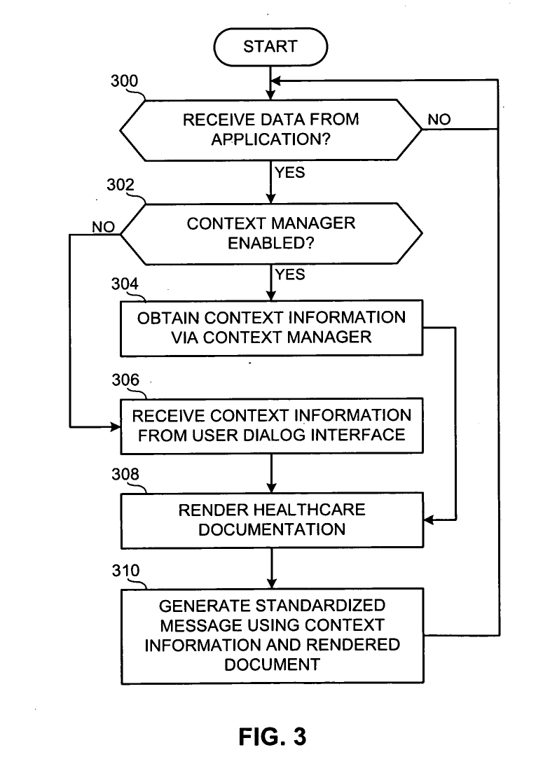

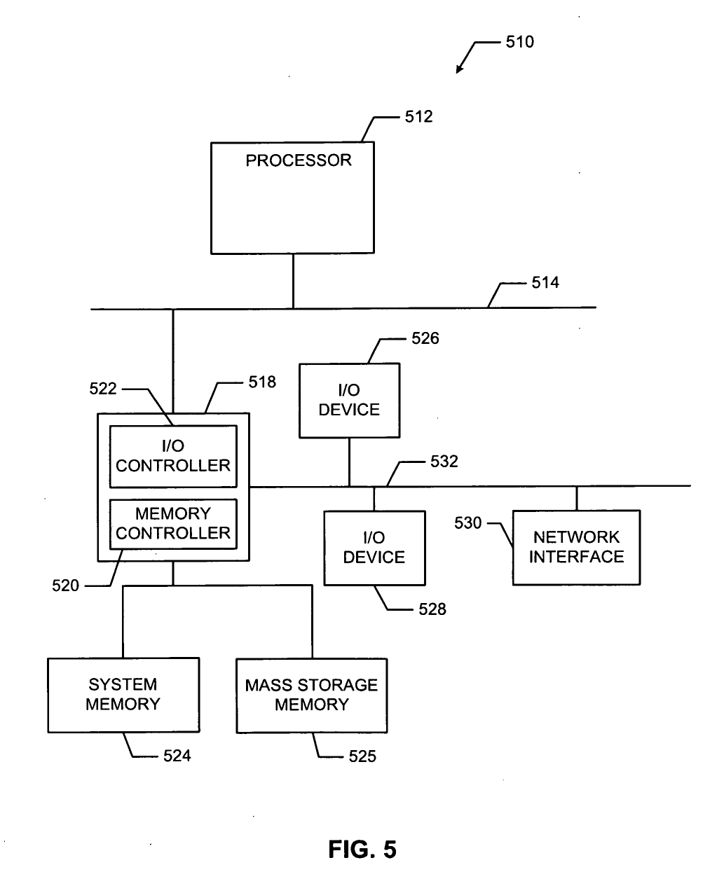

Turning to FIG. 3, the flow diagram depicted in FIG. 3 is representative of machine readable instructions that can be executed to implement the example print driver 120 of FIGS. 1 and/or 2 to share healthcare documents in health information exchanges. The example processes of FIG. 3 may be performed using a processor, a controller and/or any other suitable processing device. For example, the example processes of FIG. 3 may be implemented in coded instructions stored on a tangible medium such as a flash memory, a read-only memory (ROM) and/or random-access memory (RAM) associated with a processor (e.g., the example processor 512 discussed below in connection with FIG. 5). Alternatively, some or all of the example processes of FIG. 3 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 3 may be implemented manually or as any combination(s) of any of the foregoing techniques, for example, any combination of firmware, software, discrete logic and/or hardware. Further, although the example processes of FIG. 3 are described with reference to the flow diagram of FIG. 3, other methods of implementing the processes of FIG. 3 may be employed. For example, the order of execution of the blocks may be changed, and/or some of the blocks described may be changed, eliminated, sub-divided, or combined. Additionally, any or all of the example processes of FIG. 3 may be performed sequentially and/or in parallel by, for example, separate processing threads, processors, devices, discrete logic, circuits, etc.

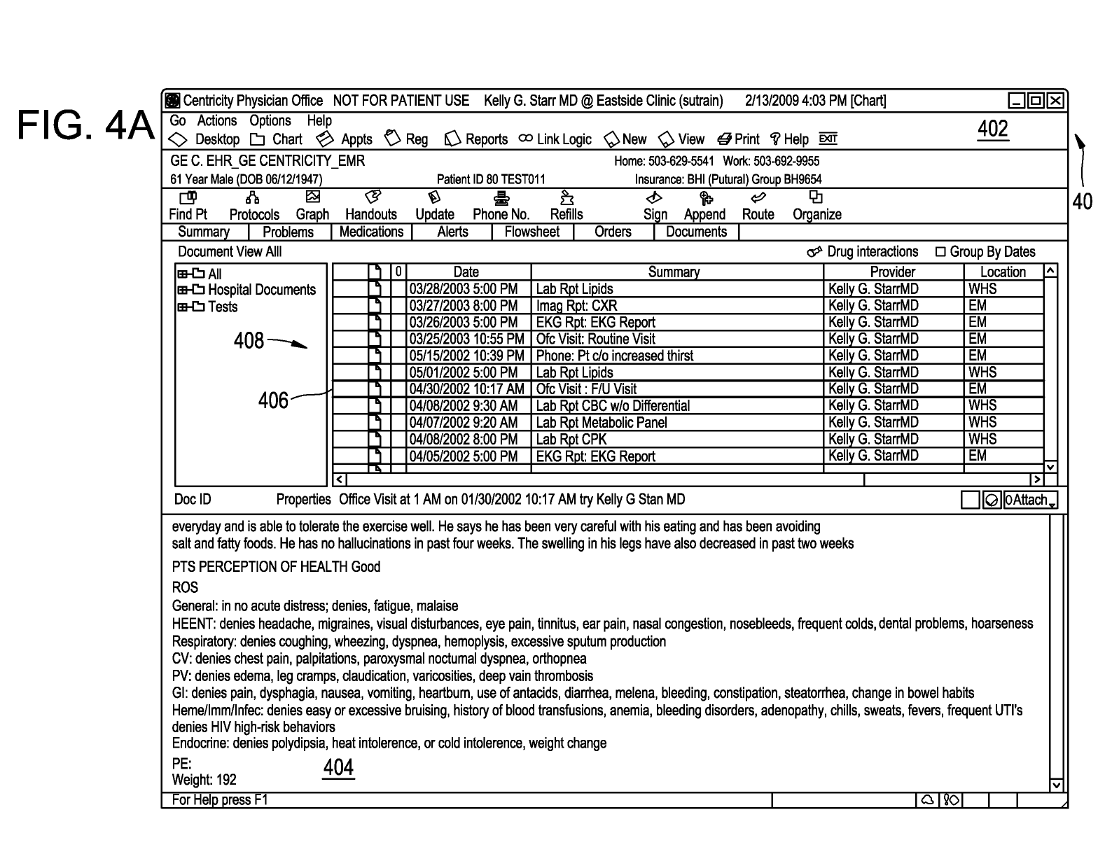

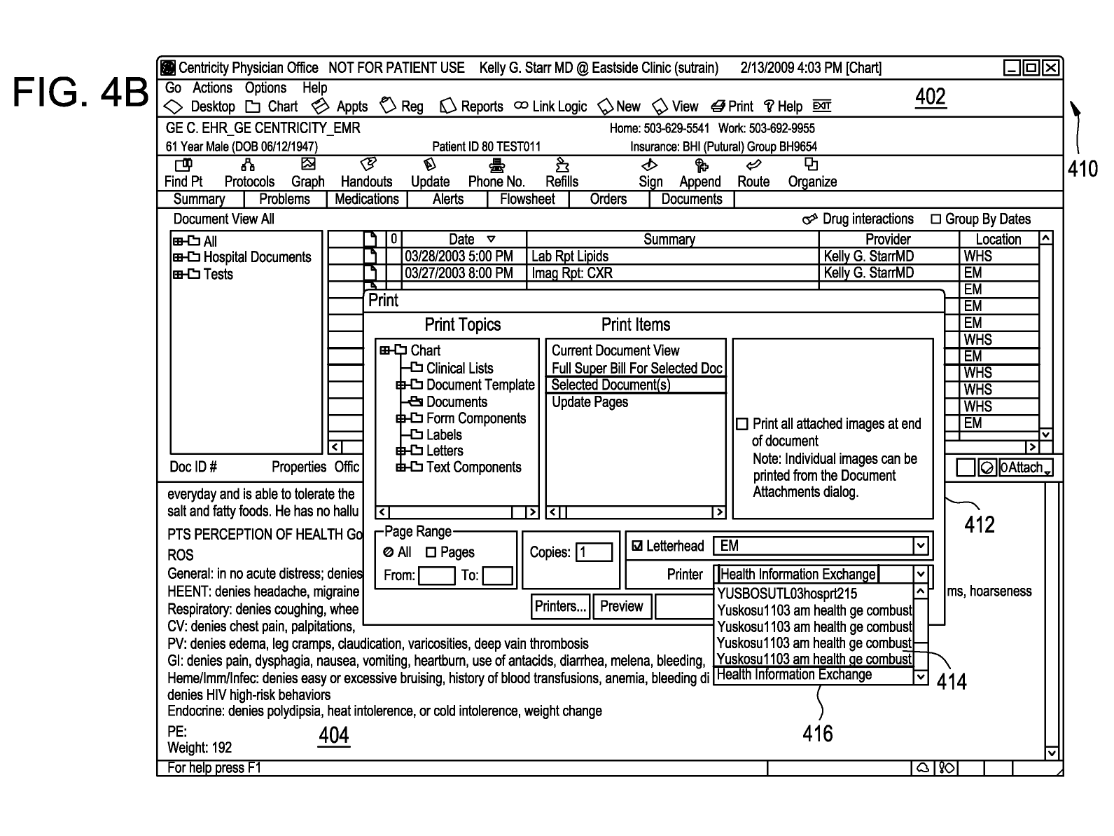

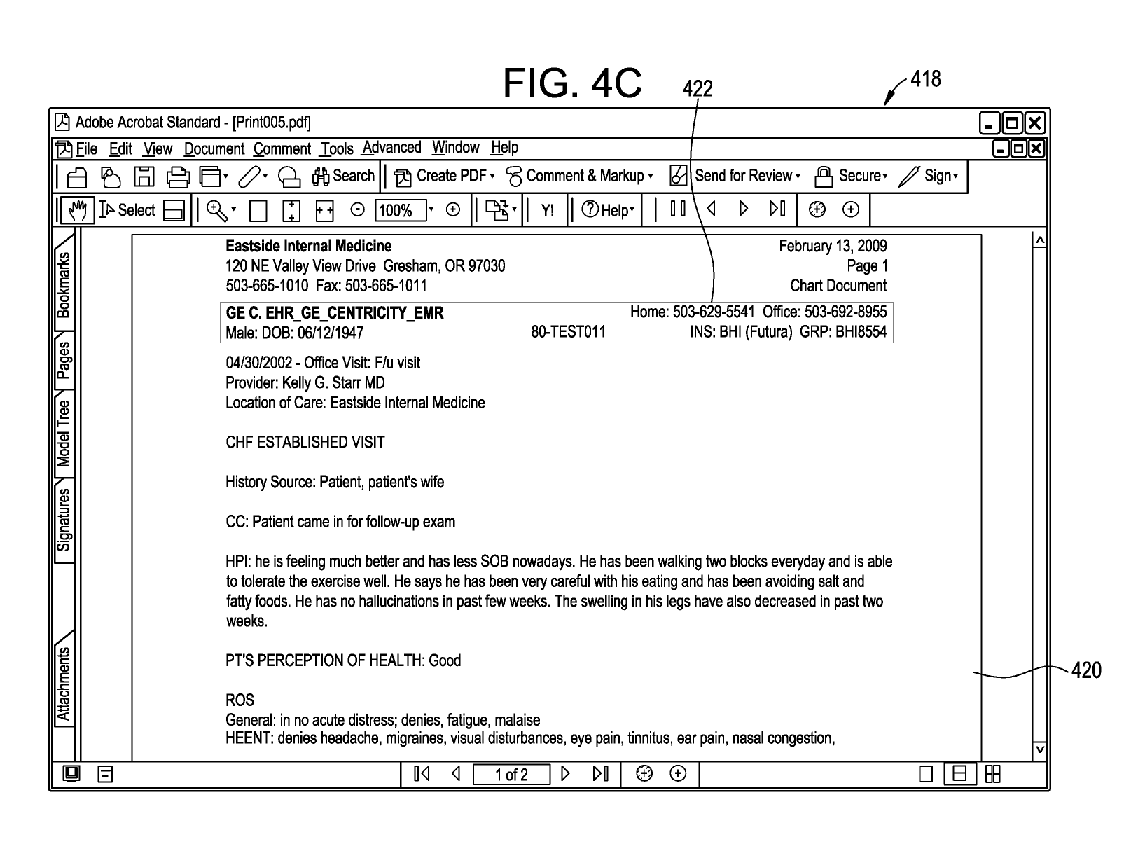

FIGS. 4A-C are example screenshots illustrative of an example display associated with the example print driver of FIGS. 1 and/or 2 and/or the example machine readable instructions of FIG. 3. FIGS. 4A-C are described below in conjunction with FIG. 3 for purposes of illustration and not limitation.

In the illustrated example of FIG. 3, the print driver 120 can be triggered by one or more of the applications 118 (FIG. 1) of the medical information system 106 (FIG. 1) attempting to upload or otherwise communicate information to an HIE, an RHIO, and/or any other information sharing system (e.g., the XDS system of FIG. 1). For example, as illustrated in a screenshot 400 of FIG. 4A, an EMR application 402 (e.g., one of the application(s) 118 of FIG. 1) dedicated to interacting with the EMR system 113 (FIG. 1) can obtain a clinical report 404 from the EMR 113 associated with a first patient. The EMR application 402 may have retrieved the clinical report 402 in response to a user entering identifying information corresponding to the first patient into the EMR application 402 and clicking on an entry 406 in a list 408.

If the EMR application 402 then attempts to share the application information (e.g., the clinical report 404) with, for example, the XDS repository 110a (FIG. 1) and/or the XDS registry 104 (FIG. 1), the EMR application 402 communicates the application information to the print driver 120 (block 300 of FIG. 3). For example, as shown in a screenshot 410 of FIG. 4B, the application 402 may display a communication window 412 in response to a user input corresponding to a print instruction (e.g., engaging a print icon or keyboard button). The communication window 412 includes a list of options 414, one of which is an option 416 to share the clinical report 404 with a HIE. In the illustrated example, the selection of the option 416 to share the clinical report 404 triggers the conveyance of the application information to the print driver 120 (block 300 of FIG. 3). In some examples, the EMR application 402 may check for compliance with the destination sharing system (e.g., the XDS system, an HIE, an RHIO, etc.) before communicating the application information to the print driver 120.

In response to receiving the application information, the print driver 120 determines whether the context manager 202 (FIG. 2) is enabled (block 302). In the illustrated example, the context manger 202 is enabled by default but can be disabled in response to, for example, user input or technical problems therewith. If the context manager 202 is enabled, the context manager 202 obtains the context information associated with the received application information (block 304). As described above, the context manager 202 of the illustrated example obtains the context information from, for example, the context management tools of a CCOW system. However, the context manger 202 may use additional or alternative resources to obtain the context information.

Referring back to block 302, if the context manager 202 is disabled, the user dialog interface 206 (FIG. 2) obtains the context information (block 306). As described above, the user dialog interface 206 is capable of retrieving the context information given a user input such as, for example, a patient identifier or an encounter identifier to be used in a query of a context information source.

The example print unit 200 (FIG. 2) converts the received application information (e.g., the clinical report 404) into the healthcare documentation to be combined with the retrieved context information (block 308). In the illustrated example, the print unit 200 uses the native print capabilities of the workstation(s) 108 to render a document such as, for example, a PDF document, a TIFF image, a plain text (e.g., ASCII) file, and/or any other suitable document. As described above in connection with FIG. 2, the rendered document includes the substantive medical, clinical, financial, etc. information of interest to a user of the application(s) 118.

When the context information associated with the retrieved application information has been obtained (e.g., by the context manager 202 or the user dialog interface 206) and the print unit 200 has generated the rendered document, the standardized message generator 204 (FIG. 2) combines the context information and the rendered document to generate a standardized message (block 310). As described above, the resulting standardized message is generated such that the message can be shared across the data sharing system with which the application is attempting to communicate. The generation of the standardized message may include determining (e.g., by the standardized message generator 204 and/or any other suitable component of the print driver 120) which parameters are necessary to comply with the destination data sharing system. Further, the print driver 120 may take those parameters into consideration when retrieving the context information (e.g., via the context manager 202).

FIG. 4C is an example screenshot 418 including an example standardized message 420 generated by the example standardized message generator 204 (block 310 of FIG. 3). In the illustrated example, the clinical report 404 of FIG. 4A is combined with an XML header to conform with the HL-7 CDA standard. In the illustrated example, the standardized message 420 is produced in the PDF format. As shown in the example screenshot 418 of FIG. 4C, the XML header 422 includes patient demographic information and other metadata obtained by, for example, the example context manager 202 of FIG. 2. As described above, the context information of the XML header 422 can be obtained in any suitable manner such as, for example, via a CCOW system and/or other context management tools (e.g., tools supported by GE Centricity Web Framework®). Further, the XML header 422 is an example of conforming to the example standard of CDA system(s). In some examples, the context information may be combined with the application information in additional or alternative manners to conform with additional or alternative standards and/or protocols.

FIG. 5 is a block diagram of an example processor system 510 that may be used to implement the apparatus and methods described herein. As shown in FIG. 5, the processor system 510 includes a processor 512 that is coupled to an interconnection bus 514. The processor 512 may be any suitable processor, processing unit or microprocessor. Although not shown in FIG. 5, the system 510 may be a multi-processor system and, thus, may include one or more additional processors that are identical or similar to the processor 512 and that are communicatively coupled to the interconnection bus 514.

The processor 512 of FIG. 5 is coupled to a chipset 518, which includes a memory controller 520 and an input/output (I/O) controller 522. As is well known, a chipset typically provides I/O and memory management functions as well as a plurality of general purpose and/or special purpose registers, timers, etc. that are accessible or used by one or more processors coupled to the chipset 518. The memory controller 520 performs functions that enable the processor 512 (or processors if there are multiple processors) to access a system memory 524 and a mass storage memory 525.

The system memory 524 may include any desired type of volatile and/or non-volatile memory such as, for example, static random access memory (SRAM), dynamic random access memory (DRAM), flash memory, read-only memory (ROM), etc. The mass storage memory 525 may include any desired type of mass storage device including hard disk drives, optical drives, tape storage devices, etc.

The I/O controller 522 performs functions that enable the processor 512 to communicate with peripheral input/output (I/O) devices 526 and 528 and a network interface 530 via an I/O bus 532. The I/O devices 526 and 528 may be any desired type of I/O device such as, for example, a keyboard, a video display or monitor, a mouse, etc. The network interface 530 may be, for example, an Ethernet device, an asynchronous transfer mode (ATM) device, an 802.11 device, a DSL modem, a cable modem, a cellular modem, etc. that enables the processor system 510 to communicate with another processor system.

While the memory controller 520 and the I/O controller 522 are depicted in FIG. 5 as separate blocks within the chipset 518, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method for use with a medical information system, comprising:
receiving healthcare information from an application operating according to a first standard;
obtaining context information associated with the healthcare information;
generating a document including at least a portion of the healthcare information; and
combining the context information and the document to form a standardized message capable of being shared with an information exchange operating according to a second standard.

2. A computer implemented method as defined in claim 1, further comprising uploading the standardized message to the information exchange, wherein the first standard and the second standard are different.

3. A computer implemented method as defined in claim 1, wherein obtaining the context information associated with the healthcare information comprises accessing a resource of a context manager system.

4. A computer implemented method as defined in claim 1, wherein the standardized message is to be generated without alteration to the application and without conveying the healthcare information to an interface engine.

5. A computer implemented method as defined in claim 1, wherein obtaining the context information associated with the healthcare information comprises retrieving identifying information related to a patient from a database in response to a query including a patient identifier.

6. A computer implemented method as defined in claim 1, further comprising determining one or more parameters needed to generate the standardized message according to the second standard associated with the information exchange.

7. A computer implemented method as defined in claim 1, wherein generating the document comprises using native print capabilities of a system implementing the application.

8. A computer implemented method as defined in claim 1, wherein the context information comprises identifying information associated with a patient related to the healthcare information.

9. A method as defined in claim 1, wherein the standardized message is generated according to HL-7 Medical Document Management standards.

10. A computer implemented method as defined in claim 1, further comprising wrapping the standardized message according to the HL-7 Clinical Document Architecture.

11. An apparatus for use with a medical information system, comprising:
a context manager to obtain context information associated with healthcare information received from an application operating according to a first standard;
a print unit to generate a document including at least a portion of the healthcare information; and
a standardized message generator to combine the context information and the document to form a standardized message capable of being shared with an information exchange operating according to a second standard.

12. An apparatus as defined in claim 11, wherein the context manager obtains the context information associated with the healthcare information by accessing a resource of Clinical Context Object Workgroup system.

13. An apparatus as defined in claim 11, further comprising a user dialog interface to obtain the context information associated with the healthcare information by retrieving identifying information related to a patient from a database in response to a query including a patient identifier.

14. An apparatus as defined in claim 11, wherein the standardized message generator determines one or more parameters needed to generate the standardized message according to the second standard associated with the information exchange.

15. An apparatus as defined in claim 11, wherein the print unit generates the document using native print capabilities of a system implementing the application.

16. An apparatus as defined in claim 10, wherein the standardized message includes the document as a payload of a HL-7 message.

17. An apparatus as defined in claim 10, wherein the apparatus comprises a machine readable medium having executable instructions stored thereon.

18. A medical data sharing system, comprising:
a healthcare enterprise communicatively coupled to a health information exchange, wherein the health information exchange operates according to a first standard;
a medical information system associated with the healthcare enterprise including a plurality of sources of healthcare information;
an application capable of communicating with at least one of the sources of healthcare information, wherein the application operates according to a second standard different from the first standard; and
a print driver configured to receive an instance of healthcare information from the application, the print driver comprising:
a context manager to obtain context information associated with the instance of healthcare information;
a print unit to generate a document including at least a portion of the instance of healthcare information; and
a standardized message generator to combine the context information and the document to form a message standardized in accordance with the first standard of the health information exchange.

19. A medical data sharing system as defined in claim 18, wherein the print driver enables a sharing of the healthcare information without alteration of the application to comply with the first standard.

20. A medical data sharing system as defined in claim 18, wherein the standardized message generator determines one or more parameters needed to generate the standardized message according to the first standard.
